(19) United States
(12) Patent Application Publication
(10) Pub. No.: US 2024/0082831 A1
(43) Pub. Date: Mar. 14, 2024

(54) METHODS FOR MAKING SUPPORTED LATE TRANSITION METAL CATALYSTS

(71) Applicant: Chevron Phillips Chemical Company LP, The Woodlands, TX (US)

(72) Inventors: Orson L. Sydora, Sugar Land, TX (US); Mark L. Hlavinka, Kingwood, TX (US); Cori A. Demmelmaier-Chang, Houston, TX (US)

(21) Appl. No.: 18/456,557

(22) Filed: Aug. 28, 2023

Related U.S. Application Data
(60) Provisional application No. 63/401,734, filed on Aug. 29, 2022.

(51) Int. Cl. B01J 31/18; B01J 21/04; B01J 21/08; B01J 31/22; B01J 35/02; B01J 35/10; B01J 37/02; B01J 37/04

(52) U.S. Cl. CPC B01J 31/1815; B01J 21/04; B01J 21/08; B01J 31/22; B01J 35/023; B01J 35/026; B01J 35/1014; B01J 35/1019; B01J 35/1023; B01J 35/1038; B01J 35/1042; B01J 35/1047; B01J 37/0203; B01J 37/04; B01J 2531/842; B01J 2531/845

(57) ABSTRACT

Supported catalysts contain a transition metal compound impregnated on or bound to a solid support, and the transition metal is iron, cobalt, or manganese. The solid support is an inorganic solid oxide or a chemically-treated solid oxide. The transition metal compound is prepared by reacting a transition metal halide containing a ligand with an alkylating agent in a suitable reaction medium at a temperature of −70 to 15° C., prior to impregnating onto the solid support.

### REFERENCE TO RELATED APPLICATION

This application claims the benefit of U.S. Provisional Patent Application No. 63/401,734, filed on Aug. 29, 2022, the disclosure of which is incorporated herein by reference in its entirety.

### FIELD OF THE INVENTION

The present disclosure generally relates to methods for making Group VII or Group VIII transition metal compounds, such as transition metal alkyls, and the supported transition metal catalysts formed therefrom. These catalysts can be used, for instance, in metathesis and hydrocarbon cracking applications.

### BACKGROUND

Catalysts utilizing early transition metals, such as tungsten, molybdenum, tantalum, and titanium, are often used in metathesis and hydrocarbon cracking applications to produce light hydrocarbons. However, these early transition metal catalysts suffer from poor activity, short lifetimes, and sensitivity to water and polar moieties. It would be beneficial to utilize supported transition metal catalysts that do not have these drawbacks. Accordingly, it is to these ends that the present invention is generally directed.

### SUMMARY

This summary is provided to introduce a selection of concepts in a simplified form that are further described below in the detailed description. This summary is not intended to identify required or essential features of the claimed subject matter. Nor is this summary intended to be used to limit the scope of the claimed subject matter.

Supported transition metal catalysts are disclosed and described herein. Such supported catalysts generally can comprise a transition metal compound having formula (A) or formula (B) impregnated on (or bound to) a solid support. Formula (B) is (L)ₓMR₂, and formula (A) is:

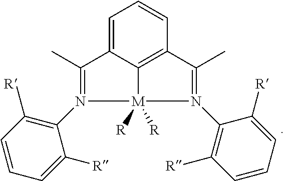

In these formulas, M is Fe, Co, or Mn; each R independently is a C₁-C₁₈ hydrocarbyl group or a C₁-C₁₈ hydrocarbylsilyl group; each R′ and R″ independently are H or a C₁-C₁₈ hydrocarbyl group; L is a monodentate, bidentate, or tridentate ligand; and x is equal to 1 or 2.

Methods of making transition metal compounds also are provided herein. For instance, methods for making a transition metal compound having the following formula: (L)ₓMR₂ (B), can comprise contacting a compound having formula (C) with a compound having formula (D) in a reaction medium at a temperature in a range from −70° C. to 15° C. to form the compound having formula (B). Formula (C) is (L)_{y}MX₂, and formula (D) is LiR, MgRX, MgR₂, or ZnR₂. In these formulas, M is Fe, Co, or Mn; each R independently is a C₁-C₁₈ hydrocarbyl group or a C₁-C₁₈ hydrocarbylsilyl group; L is a monodentate or bidentate ligand; each X independently is a halogen; x is equal to 1 or 2; and y is equal to 2 or 4.

Both the foregoing summary and the following detailed description provide examples and are explanatory only. Accordingly, the foregoing summary and the following detailed description should not be considered to be restrictive. Further, features or variations may be provided in addition to those set forth herein. For example, certain aspects may be directed to various feature combinations and sub-combinations described in the detailed description.

### BRIEF DESCRIPTION OF THE FIGURES

The following figures form part of the present specification and are included to further demonstrate certain aspects of the present invention. The invention may be better understood by reference to one or more of these figures in combination with the detailed description and examples.

FIG. 1 is a reaction scheme for Example 7, which illustrates a proposed supported iron catalyst structure.

FIG. 2 presents a FT-IR plot of the supported iron catalyst of Example 7.

FIG. 3 presents a FT-IR plot of the supported iron hydride catalyst of Example 7, which is formed after treatment with hydrogen (H₂).

### DEFINITIONS

To define more clearly the terms used herein, the following definitions are provided. Unless otherwise indicated, the following definitions are applicable to this disclosure. If a term is used in this disclosure but is not specifically defined herein, the definition from the IUPAC Compendium of Chemical Terminology, 2^{nd} Ed (1997), can be applied, as long as that definition does not conflict with any other disclosure or definition applied herein, or render indefinite or non-enabled any claim to which that definition is applied. To the extent that any definition or usage provided by any document incorporated herein by reference conflicts with the definition or usage provided herein, the definition or usage provided herein controls.

Herein, features of the subject matter are described such that, within particular aspects, a combination of different features can be envisioned. For each and every aspect and each and every feature disclosed herein, all combinations that do not detrimentally affect the processes or methods described herein are contemplated with or without explicit description of the particular combination. Additionally, unless explicitly recited otherwise, any aspect or feature disclosed herein can be combined to describe inventive compositions or methods consistent with the present disclosure.

For any particular compound or group disclosed herein, any name or structure (general or specific) presented is intended to encompass all conformational isomers, regioisomers, stereoisomers, and mixtures thereof that can arise from a particular set of substituents, unless otherwise specified. The name or structure (general or specific) also encompasses all enantiomers, diastereomers, and other optical isomers (if there are any) whether in enantiomeric or racemic forms, as well as mixtures of stereoisomers, as would be recognized by a skilled artisan, unless otherwise specified. For instance, a general reference to pentane includes n-pentane, 2-methyl-butane, and 2,2-dimethylpropane; and a general reference to a butyl group includes a n-butyl group, a sec-butyl group, an iso-butyl group, and a t-butyl group.

In this disclosure, while compositions and methods are described in terms of “comprising” various components or steps, the compositions and methods also can “consist essentially of” or “consist of” the various components or steps, unless stated otherwise. The terms “a,” “an,” and “the” are intended to include plural alternatives, e.g., at least one, unless otherwise specified.

The term “hydrocarbon” whenever used in this specification and claims refers to a compound containing only carbon and hydrogen, whether saturated or unsaturated. Other identifiers can be utilized to indicate the presence of particular groups in the hydrocarbon (e.g., halogenated hydrocarbon indicates that the presence of one or more halogen atoms replacing an equivalent number of hydrogen atoms in the hydrocarbon). The term “hydrocarbyl group” is used herein in accordance with the definition specified by IUPAC: a univalent group formed by removing a hydrogen atom from a hydrocarbon (that is, a group containing only carbon and hydrogen). Non-limiting examples of hydrocarbyl groups include alkyl, alkenyl, aryl, and aralkyl groups, amongst other groups.

Several types of ranges are disclosed in the present invention. When a range of any type is disclosed or claimed, the intent is to disclose or claim individually each possible number that such a range could reasonably encompass, including end points of the range as well as any sub-ranges and combinations of sub-ranges encompassed therein. For example, when a chemical moiety having a certain number of carbon atoms is disclosed or claimed, the intent is to disclose or claim individually every possible number that such a range could encompass, consistent with the disclosure herein. For example, the disclosure that a moiety is a C₁ to C₁₈ hydrocarbyl group, or in alternative language, a hydrocarbyl group having from 1 to 18 carbon atoms, as used herein, refers to a moiety that can have 1, 2, 3, 4, 5, 6, 7, 8, 9, 10, 11, 12, 13, 14, 15, 16, 17, or 18 carbon atoms, as well as any range between these two numbers (for example, a C₁ to C₈ hydrocarbyl group), and also including any combination of ranges between these two numbers (for example, a C₂ to C₄ and a C₁₂ to C₁₆ hydrocarbyl group).

Similarly, another representative example follows for the amount of the transition metal on the supported catalyst. By a disclosure that the supported catalyst contains from 0.01 to 20 wt. % of the transition metal, the intent is to recite that the amount of the transition metal can be any amount within the range and, for example, can include any range or combination of ranges from 0.01 to 20 wt. %, such as from 0.01 to 10 wt. %, from 0.05 to 15 wt. %, from 0.1 to 15 wt. %, from 0.2 to 10 wt. %, from 0.1 to 5 wt. %, from 0.5 to 5 wt. %, or from 0.5 to 2.5 wt. %, and so forth. Likewise, all other ranges disclosed herein should be interpreted in a manner similar to these examples.

The terms “contacting” and the like are used herein to describe compositions and methods wherein the components are contacted together in any order, in any manner, and for any length of time. For example, the components can be contacted by blending or mixing. Further, unless otherwise specified, the contacting of any component can occur in the presence or absence of any other component of the compositions and methods described herein. Combining additional materials or components can be done by any suitable method. Further, the term “contacting” can result in mixtures, blends, solutions, slurries, reaction products, and the like, or combinations thereof. It is not required that the respective components react with one another. Alternatively, “contacting” two or more components can result in a reaction product or a reaction mixture.

In general, an amount, size, formulation, parameter, range, or other quantity or characteristic is “about” or “approximate” whether or not expressly stated to be such. Whether or not modified by the term “about” or “approximately,” the claims include equivalents to the quantities or characteristics.

Although any methods, devices, and materials similar or equivalent to those described herein can be used in the practice or testing of the invention, the typical methods, devices, and materials are herein described.

All publications and patents mentioned herein are incorporated herein by reference in their entirety for the purpose of describing and disclosing, for example, the constructs and methodologies that are described in the publications and patents, which might be used in connection with the presently described invention.

### DETAILED DESCRIPTION

It is contemplated herein that cracking catalysts comprising Group VII and Group VIII transition metals (i.e., groups of the periodic table beginning with Mn, Fe, Co, and Ni) may have an improved tolerance to hydrocarbon mixtures comprising polar groups, as can be found within polyethylene plastic waste and intermediate pyrolysis products thereof. It is also contemplated herein that transition metal alkyls may provide a practical precatalytic pathway for the preparation of analogous metal hydride cracking catalysts, for example, by contact with H₂ at a suitable activation temperature. However, late transition metal alkyls (Mn through Ni) are often unstable at ambient temperatures which has limited their use as cracking catalysts.

Transition metal catalysts are disclosed herein that can be prepared at low to ambient temperatures and successfully loaded onto inorganic solid supports, forming stable Group VII and Group VIII transition metal supported catalysts.

### Supported Transition Metal Compounds

Disclosed herein are supported catalysts comprising a transition metal compound having formula (A) or formula (B) impregnated on (or in alternative language, bound to) a solid support. Formula (B) is (L)ₓMR₂, and formula (A) is:

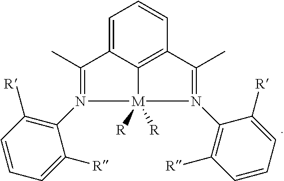

Within formula (A), M, each R, each R′, and each R″ are independent elements of the transition metal compound. Accordingly, the transition metal compound having formula (A) can be described using any combination of M, R, R′, and R″ disclosed herein. Similarly, within formula (B), L, x, M, and each R are independent elements of the transition metal compound.

Accordingly, the transition metal compound having formula (B) can be described using any combination of L, x, M, and R disclosed herein.

Unless otherwise specified, formulas (A) and (B) above, any other structural formulas disclosed herein, and any ligand, complex, compound, or species disclosed herein are not designed to show stereochemistry or isomeric positioning of the different moieties (e.g., these formulas are not intended to display rac or meso isomers, or R or S diastereoisomers), although such compounds are contemplated and encompassed by these formulas and/or structures, unless stated otherwise.

In formulas (A) and (B), M can be Fe, Co, or Mn; each R independently can be a C₁-C₁₈ hydrocarbyl group or a C₁-C₁₈ hydrocarbylsilyl group; each R′ and R″ independently can be H or a C₁-C₁₈ hydrocarbyl group; L can be a monodentate, bidentate, or tridentate ligand; and x can be equal to 1 or 2. In some aspects of this invention, the transition metal compound can have formula (A), while in other aspects, the transition metal compound can have formula (B).

The metal in formulas (A) and (B), M, can be Fe, Co, or Mn, and thus in one aspect, for instance, M can be Fe or Co, while in another aspect, M can be Fe; alternatively, M can be Co; or alternatively, M can be Mn.

Each R independently can be a C₁-C₁₈ hydrocarbyl group or a C₁-C₁₈ hydrocarbylsilyl group. It is contemplated that each R can be either the same or different. For example, each R independently can be a C₁-C₁₈ hydrocarbyl group or a C₁-C₁₈ hydrocarbylsilyl group, and hydrocarbyl groups and hydrocarbylsilyl groups, independently, can be C₁-C₁₂ groups, or C₁-C₈ groups, or C₄-C₁₈ groups, or C₄-C₁₂ groups, or C₄-C₈ groups.

Any hydrocarbyl group, independently, can be an alkyl group, a cycloalkyl group, an aryl group (e.g., a phenyl group or a naphthyl group, optionally substituted), or an aralkyl group (e.g., a benzyl group, optionally substituted), and likewise for hydrocarbylsilyl groups. While not limited thereto, each R in formulas (A) and (B) independently can be a methyl group, an ethyl group, a propyl group (n-propyl group or iso-propyl group), a butyl group (n-butyl group, iso-butyl group, sec-butyl group, or tert-butyl group), a pentyl group (n-pentyl group, iso-pentyl group, sec-pentyl group, or neopentyl group), a hexyl group, a heptyl group, an octyl group, a nonyl group, a decyl group, a cyclobutyl group, a cyclopentyl group, a cyclohexyl group, a cycloheptyl group, an adamantyl group, a phenyl group, a mesityl group, a naphthyl group, or a benzyl group. For instance, each R independently can be a methyl group, a neopentyl group, a phenyl group, a mesityl group, or a benzyl group.

The hydrocarbylsilyl group that can be an R group can be a C₁ to C₁₈ hydrocarbylsilyl group; alternatively, a C₁ to C₁₂ hydrocarbylsilyl group; alternatively, a C₄ to C₁₈ hydrocarbylsilyl group; or alternatively, a C₄ to C₁₂ hydrocarbylsilyl group. As used herein, hydrocarbylsilyl is intended to cover (mono)hydrocarbylsilyl, dihydrocarbylsilyl, and trihydrocarbylsilyl groups. Illustrative and non-limiting examples of hydrocarbylsilyl groups which can be an R in formula (A) and formula (B) can include, but are not limited to, CH₂SiMe₃, trimethylsilyl, triethylsilyl, tripropylsilyl (e.g., triisopropylsilyl), tributylsilyl, tripentylsilyl, triphenylsilyl, allyldimethylsilyl, and the like.

In accordance with certain aspects of this invention, each R independently can be CH₂SiMe₃, CH₂CMe₃, CH₂Ph, or CH₂CMe₂Ph, and the like, where Me is methyl and Ph is phenyl.

Each R′ and R″ in formula (A) independently can be H or a C₁-C₁₈ hydrocarbyl group, and any hydrocarbyl options noted herein for R also can apply to R′ and R″. Accordingly, in one aspect, each R′ and R″ independently can be H, a methyl group, an ethyl group, a propyl group (n-propyl group or iso-propyl group), a butyl group (n-butyl group, iso-butyl group, sec-butyl group, or tert-butyl group), a pentyl group (n-pentyl group, iso-pentyl group, sec-pentyl group, or neopentyl group), a hexyl group, a heptyl group, an octyl group, a nonyl group, a decyl group, a cyclobutyl group, a cyclopentyl group, a cyclohexyl group, a cycloheptyl group, an adamantyl group, a phenyl group, a mesityl group, a naphthyl group, or a benzyl group. In another aspect, each R′ and R″ independently can be H, a methyl group, an ethyl group, a propyl group (n-propyl group or iso-propyl group), a butyl group (n-butyl group, iso-butyl group, sec-butyl group, or tert-butyl group), or a pentyl group (n-pentyl group, iso-pentyl group, sec-pentyl group, or neopentyl group).

Referring now to formula (B), L can a monodentate, bidentate, or tridentate ligand, and x can be equal to 1 or 2. For instance, x can be equal to 1 when L is a bidentate or tridentate ligand, while x can be equal to 2 when L is a monodentate ligand. While not limited thereto, representative monodentate ligands include pyridine and phosphorus-containing ligands, such as PMe₃, PEt₃, PEt₂Ph, PBu₃, and the like, where Me is methyl, Et is ethyl, Ph is phenyl, and Bu is butyl. Likewise, representative and non-limiting examples of bidentate ligands include sparteine, tetramethylethylenediamine (tmeda), and bisphosphines (diphosphines), and illustrative tridentate ligands include pyridine dicarbenes.

Representative and non-limiting examples of precursor transition metal compounds that can used to produce the disclosed supported catalysts are disclosed in, for instance, Bart et al, Organometallics, 2004, 23, 237-246 (e.g., (sparteine)Mn(CH₂SiMe₃)₂); Campora et al, Organometallics, 2005, 24, 4878-4881 (e.g., (py)₂FeR₂, where R is CH₂SiMe₃, CH₂CMe₃, CH₂Ph, CH₂CMe₂Ph); Hawrelak et al, Inorg. Chem., 2005, 44, 3103-3111 (e.g., (PR₃)₂FeR₂, where R is mesityl and PR₃ is PEt₃ or PEt₂Ph); Zhu et al, Organometallics, 2010, 29, 1897-1908 (e.g., (py)₂Co(CH₂SiMe₃)₂, (tmeda)₂Co(CH₂SiMe₃)₂); Friedfeld et al, Science, 2013, 342, 1076-1080 (e.g., (bisphosphine)Co(CH₂SiMe₃)₂ with various bisphosphine ligands); and Rummelt et al, Organometallics, 2019, 38, 3159-3168 (e.g., iron compounds with pyridine dicarbene ligands).

The supported catalyst contains the transition metal compound having formula (A) or the transition metal compound having formula (B) impregnated on (or bound to) a solid support, and any suitable solid support can be utilized, as discussed hereinbelow. The amount of the respective transition metal present on the supported catalyst is not particularly limited. Generally, however, the supported catalyst can contain from 0.01 to 20 wt. % of the transition metal (independently, Fe or Co or Mn). In some aspects, the supported catalyst contains from 0.01 to 10 wt. %, from 0.05 to 15 wt. %, from 0.1 to 15 wt. %, or from 0.2 to 10 wt. % of the transition metal (independently, Fe or Co or Mn), while in other aspects, the supported catalyst contains from 0.1 to 5 wt. %, from 0.5 to 5 wt. %, or from 0.5 to 2.5 wt. % of the transition metal (independently, Fe or Co or Mn). These amounts are based on the total weight of the supported catalyst.

Herein, the terms “supported catalyst,” “supported transition metal catalyst,” and the like, do not depend upon the actual product or composition resulting from the contact or reaction of the initial transition metal compound—having formula (A) or formula (B)—with the solid support, or the fate of the initial transition metal compound, after combining these components. Therefore, the terms “supported catalyst,” “supported transition metal catalyst,” and the like, encompass the initial starting components as well as whatever product(s) may result from contacting these initial starting components. For instance, the disclosure of a supported catalyst comprising a transition metal compound having formula (A) or formula (B) impregnated on a solid support is meant to encompass the supported catalyst in which an R group is cleaved when the transition metal compound is bound to the solid support. This is described further in the examples that follow.

### Solid Supports

Generally, any suitable solid support can be used for the supported transition metal catalyst, and typically, the solid support can be an inorganic solid support. In one aspect, the solid support can comprise a solid oxide, which can contain oxygen and one or more elements selected from Group 2, 3, 4, 5, 6, 7, 8, 9, 10, 11, 12, 13, 14, or 15 of the periodic table, or comprise oxygen and one or more elements selected from the lanthanide or actinide elements (See: Hawley's Condensed Chemical Dictionary, 11^{th} Ed., John Wiley & Sons, 1995; Cotton, F. A., Wilkinson, G., Murillo, C. A., and Bochmann, M., Advanced Inorganic Chemistry, 6^{th} Ed., Wiley-Interscience, 1999). For example, the solid oxide can comprise oxygen and an element, or elements, selected from Al, B, Be, Bi, Cd, Co, Cr, Cu, Fe, Ga, La, Mn, Mo, Ni, Sb, Si, Sn, Sr, Th, Ti, V, W, P, Y, Zn, and Zr. Illustrative examples of solid oxide materials or compounds that can be used as the solid support for the catalyst can include, but are not limited to, Al₂O₃, B₂O₃, BeO, Bi₂O₃, CdO, Co₃O₄, Cr₂O₃, CuO, Fe₂O₃, Ga₂O₃, La₂O₃, Mn₂O₃, MoO₃, NiO, P₂O₅, Sb₂O₅, SiO₂, SnO₂, SrO, ThO₂, TiO₂, V₂O₅, WO₃, Y₂O₃, ZnO, ZrO₂, and the like, including mixed oxides thereof, and combinations thereof.

The solid oxide can encompass oxide materials such as silica, alumina, or titania, “mixed oxide” compounds thereof such as silica-titania, and combinations or mixtures of more than one solid oxide material. Mixed oxides such as silica-titania can be single or multiple chemical phases with more than one metal combined with oxygen to form the solid oxide. Examples of mixed oxides that can be used as the solid oxide include, but are not limited to, silica-alumina, silica-coated alumina, silica-titania, silica-zirconia, alumina-titania, alumina-zirconia, zinc-aluminate, alumina-boria, silica-boria, aluminum phosphate, aluminophosphate, aluminophosphate-silica, titania-zirconia, and the like, or a combination thereof. In some aspects, the solid support can comprise silica, silica-alumina, silica-coated alumina, silica-titania, silica-titania-magnesia, silica-zirconia, silica-magnesia, silica-boria, aluminophosphate-silica, and the like, or any combination thereof. Silica-coated aluminas are encompassed herein; such oxide materials are described in, for example, U.S. Pat. Nos. 7,884,163 and 9,023,959.

The percentage of each oxide in a mixed oxide can vary depending upon the respective oxide material. As an example, a silica-alumina (or silica-coated alumina) typically has an alumina content from 5 wt. % to 95 wt. %. According to one aspect, the alumina content of the silica-alumina (or silica-coated alumina) can be from 5 wt. % to 50 wt. % alumina, or from 8 wt. % to 30 wt. % alumina. In another aspect, high alumina content silica-aluminas (or silica-coated aluminas) can be employed, in which the alumina content of these materials typically ranges from 60 wt. % alumina to 90 wt. % alumina, or from 65 wt. % alumina to 80 wt. % alumina.

In one aspect, the solid oxide can comprise silica-alumina, silica-coated alumina, silica-titania, silica-zirconia, alumina-titania, alumina-zirconia, zinc-aluminate, alumina-boria, silica-boria, aluminum phosphate, aluminophosphate, aluminophosphate-silica, titania-zirconia, or a combination thereof; alternatively, silica, silica-alumina, silica-coated alumina, silica-titania, silica-titania-magnesia, silica-zirconia, silica-magnesia, silica-boria, aluminophosphate-silica, alumina, alumina borate, or any combination thereof alternatively, silica; alternatively, silica-alumina; alternatively, silica-coated alumina; alternatively, silica-titania; alternatively, silica-zirconia; alternatively, alumina-titania; alternatively, alumina-zirconia; alternatively, zinc-aluminate; alternatively, alumina-boria; alternatively, silica-boria; alternatively, aluminum phosphate; alternatively, aluminophosphate; alternatively, aluminophosphate-silica; or alternatively, titania-zirconia.

In another aspect, the solid oxide can comprise silica, alumina, titania, thoria, stania, zirconia, magnesia, boria, zinc oxide, a mixed oxide thereof, or any mixture thereof. In yet another aspect, the solid oxide can comprise silica, alumina, titania, or a combination thereof; alternatively, silica; alternatively, alumina; alternatively, titania; alternatively, zirconia; alternatively, magnesia; alternatively, boria; or alternatively, zinc oxide. In still another aspect, the solid oxide can comprise silica, alumina, silica-alumina, silica-coated alumina, aluminum phosphate, aluminophosphate, heteropolytungstate, titania, zirconia, magnesia, boria, zinc oxide, silica-titania, silica-yttria, silica-zirconia, alumina-titania, alumina-zirconia, zinc-aluminate, alumina-boria, silica-boria, aluminophosphate-silica, titania-zirconia, and the like, or any combination thereof.

Consistent with certain aspects of this invention, the solid support of the supported transition metal catalyst can comprise a chemically-treated solid oxide, and where the chemically-treated solid oxide comprises a solid oxide (any solid oxide disclosed herein) treated with an electron-withdrawing anion (any electron withdrawing anion disclosed herein). The electron-withdrawing component used to treat the solid oxide can be any component that increases the Lewis or Brønsted acidity of the solid oxide upon treatment (as compared to the solid oxide that is not treated with at least one electron-withdrawing anion). According to one aspect, the electron-withdrawing component can be an electron-withdrawing anion derived from a salt, an acid, or other compound, such as a volatile organic compound, which serves as a source or precursor for that anion. Examples of electron-withdrawing anions can include, but are not limited to, sulfate, bisulfate, fluoride, chloride, bromide, iodide, fluorosulfate, fluoroborate, phosphate, fluorophosphate, trifluoroacetate, triflate, fluorozirconate, fluorotitanate, phospho-tungstate, tungstate, molybdate, and the like, including mixtures and combinations thereof. In addition, other ionic or non-ionic compounds that serve as sources for these electron-withdrawing anions also can be employed.

It is contemplated that the electron-withdrawing anion can be, or can comprise, fluoride, chloride, bromide, phosphate, triflate, bisulfate, or sulfate, and the like, or any combination thereof, in some aspects provided herein. In other aspects, the electron-withdrawing anion can comprise sulfate, bisulfate, fluoride, chloride, bromide, iodide, fluorosulfate, fluoroborate, phosphate, fluorophosphate, trifluoroacetate, triflate, fluorozirconate, fluorotitanate, and the like, or combinations thereof. Yet, in other aspects, the electron-withdrawing anion can comprise fluoride and/or sulfate.

The chemically-treated solid oxide generally can contain from 1 wt. % to 30 wt. % of the electron-withdrawing anion, based on the weight of the chemically-treated solid oxide. In particular aspects provided herein, the chemically-treated solid oxide can contain from 1 to 20 wt. %, from 2 wt. % to 20 wt. %, from 3 wt. % to 20 wt. %, from 2 wt. % to 15 wt. %, from 1 wt. % to 10 wt. %, from 2 wt. % to 10 wt. %, from 3 wt. % to 10 wt. %, of the electron-withdrawing anion, based on the total weight of the chemically-treated solid oxide.

In an aspect, the chemically-treated solid oxide can comprise fluorided alumina, chlorided alumina, bromided alumina, sulfated alumina, fluorided silica-alumina, chlorided silica-alumina, bromided silica-alumina, sulfated silica-alumina, fluorided silica-zirconia, chlorided silica-zirconia, bromided silica-zirconia, sulfated silica-zirconia, fluorided silica-titania, fluorided silica-coated alumina, fluorided-chlorided silica-coated alumina, sulfated silica-coated alumina, phosphated silica-coated alumina, and the like, as well as any mixture or combination thereof.

In another aspect, the chemically-treated solid oxide employed as the solid support for the catalysts described herein can be, or can comprise, a fluorided solid oxide and/or a sulfated solid oxide, non-limiting examples of which can include fluorided alumina, sulfated alumina, fluorided silica-alumina, sulfated silica-alumina, fluorided silica-zirconia, fluorided silica-coated alumina, sulfated silica-coated alumina, and the like, as well as combinations thereof. Additional information on chemically-treated solid oxide can be found in, for instance, U.S. Pat. Nos. 7,294,599, 7,601,665, 7,884,163, 8,309,485, 8,623,973, and 8,703,886.

The supported catalyst (or the solid support) can have any suitable pore volume and BET surface area features. Pore volumes of the supported catalyst (or the solid support) can range from 0.3 to 5 mL/g; therefore, illustrative non-limiting ranges for the pore volume include from 0.5 to 5 mL/g, from 0.3 to 3 mL/g, from 0.5 to 2 mL/g, from 0.5 to 1.8 mL/g, or from 0.7 to 1.6 mL/g, and like. Pore volumes can be determined in accordance with Halsey, G.D., J. Chem. Phys. (1948), 16, pp. 931. BET surface areas of the supported catalyst (or the solid support) can range from 50 to 1000 m²/g; therefore, illustrative non-limiting ranges for the BET surface area include from 100 to 700 m²/g, from 100 to 400 m²/g, from 150 to 500 m²/g, or from 200 to 450 m²/g, and the like. BET surface areas can be determined by the nitrogen adsorption Brunauer, Emmett, and Teller (BET) method according to ASTM D1993-91, and as described, for example, in Brunauer, S., Emmett, P. H., and Teller, E., “Adsorption of gases in multimolecular layers,” J. Am. Chem. Soc., 60, 3, pp. 309-319.

The supported catalyst (or the solid support) can have any suitable shape or form, and such can depend on the type of process that the catalyst is intended to be used (e.g., fixed bed versus fluidized bed). Illustrative and non-limiting shapes and forms include powder, round or spherical (e.g., a sphere), ellipsoidal, bead, granule (e.g., regular and/or irregular), and the like, as well as any combination thereof.

In the case of generally spherical powdered catalysts or solid supports, the supported catalyst (or the solid support) can have any suitable d50 average particle size. For instance, the d50 average particle can range from 10 to 500 μm in one aspect, from 20 to 250 μm in another aspect, from 20 to 150 μm in another aspect, from 25 to 500 μm in another aspect, from 25 to 100 μm in another aspect, from 50 to 500 μm in yet another aspect, and from 50 to 250 μm in still another aspect. Particle size distributions can be determined via laser diffraction in accordance with ISO 13320.

### Methods of Making Transition Metal Compounds

Also encompassed are methods for making transition metal compounds having formula (B), (L)ₓMR₂, and the resulting compounds can be thereafter supported onto a solid support to result in the supported transition metal catalyst. Herein, a typical method of making a transition metal compound having the formula (B) can comprise contacting a compound having formula (C) with a compound having formula (D) in a reaction medium at a temperature in a range from −70° C. to 15° C. to form the compound having formula (B). In this method, formula (C) is (L)_{y}MX₂, and formula (D) is LiR, MgRX, MgR₂, or ZnR₂.

Within formula (B), L, x, M, and each R are independent elements of the transition metal compound. Accordingly, the transition metal compound having formula (B) can be described using any combination of L, x, M, and R disclosed herein. Similarly, within formula (C), L, y, M, and each X are independent elements of the transition metal compound. Accordingly, the transition metal compound having formula (C) can be described using any combination of L, y, M, and X disclosed herein. Similarly, within formula (D), X and each R are independent elements of the alkylating compound. Accordingly, the alkylating compound having formula (D) can be described using any combination of X and R disclosed herein.

Unless otherwise specified, formulas (B) and (C) and (D) above, any other structural formulas disclosed herein, and any ligand, complex, compound, or species disclosed herein are not designed to show stereochemistry or isomeric positioning of the different moieties (e.g., these formulas are not intended to display rac or meso isomers, or R or S diastereoisomers), although such compounds are contemplated and encompassed by these formulas and/or structures, unless stated otherwise.

In formulas (B) and (C) and (D), M can be Fe, Co, or Mn; each R independently can a C₁-C₁₈ hydrocarbyl group or a C₁-C₁₈ hydrocarbylsilyl group; L can be a monodentate or bidentate ligand; each X independently can be a halogen; x can be equal to 1 or 2; and y can be equal to 2 or 4. In some aspects of this invention, the alkylating compound having formula (D) can be LiR; alternatively, MgRX; alternatively, MgR₂; or alternatively, ZnR₂.

The metal in formulas (B) and (C), M, can be Fe, Co, or Mn, and thus in one aspect, for instance, M can be Fe or Co, while in another aspect, M can be Fe; alternatively, M can be Co; or alternatively, M can be Mn.

Each R independently can be a C₁-C₁₈ hydrocarbyl group or a C₁-C₁₈ hydrocarbylsilyl group, and it is contemplated that each R can be either the same or different. Any hydrocarbyl and hydrocarbylsilyl options for R in formulas (A) and (B) described above in relation to the supported transition metal catalyst also can apply to R in formulas (B) and (D) in the disclosed methods for making transition metal compounds. Accordingly, in one aspect, each R independently can be a methyl group, an ethyl group, a propyl group (n-propyl group or iso-propyl group), a butyl group (n-butyl group, iso-butyl group, sec-butyl group, or tert-butyl group), a pentyl group (n-pentyl group, iso-pentyl group, sec-pentyl group, or neopentyl group), a hexyl group, a heptyl group, an octyl group, a nonyl group, a decyl group, a cyclobutyl group, a cyclopentyl group, a cyclohexyl group, a cycloheptyl group, an adamantyl group, a phenyl group, a mesityl group, a naphthyl group, or a benzyl group. In another aspect, each R independently can be a methyl group, a neopentyl group, a phenyl group, a mesityl group, or a benzyl group. In yet another aspect, each R independently can be a C₁-C₁₂ hydrocarbylsilyl group, a C₄-C₁₈ hydrocarbylsilyl group, or a C₄-C₁₂ hydrocarbylsilyl group. In still another aspect, each R independently can be CH₂SiMe₃, CH₂CMe₃, CH₂Ph, or CH₂CMe₂Ph, and the like, where Me is methyl and Ph is phenyl.

Likewise, the ligand (L) selections for formula (B) described above in relation to the supported transition metal catalyst also can apply to the ligand (L) in formulas (B) and (C) in the disclosed methods for making transition metal compounds. Thus, representative monodentate ligands include pyridine and phosphorus-containing ligands, such as PMe₃, PEt₃, PEt₂Ph, PBu₃, and the like, where Me is methyl, Et is ethyl, Ph is phenyl, and Bu is butyl, and representative and non-limiting examples of bidentate ligands include sparteine, tetramethylethylenediamine (tmeda), and bisphospines (diphosphines).

In formulas (B) and (C), x can be equal to 1 or 2, and y can be equal to 2 or 4. For instance, x can be equal to 1 when L is a bidentate ligand, while x can be equal to 2 when L is a monodentate ligand. Similarly, y can be equal to 2 when L is a bidentate ligand, while y can be equal to 4 when L is a monodentate ligand.

Referring now to formulas (C) and (D), each X independently can be a halogen. Therefore, each X can be bromine (Br), or each X can be chlorine (Cl), or each X can be fluorine (F). It is also possible for the compound having formula (C) to contain different halogens, for instance, (L)_{y}MBrCl.

Often, the method of making the transition metal compound having formula (B) is performed in a reaction medium, thus the compound having formula (C) can be contacted with the compound having formula (D) in any suitable reaction medium. While not limited thereto, the reaction medium can comprise a saturated aliphatic hydrocarbon, an aromatic hydrocarbon, an ether, and the like, as well as any combination thereof. Illustrative examples of saturated aliphatic hydrocarbons that can be utilized as the reaction medium, either singly or in combination, include butane (e.g., n-butane or isobutane), pentane (e.g., n-pentane, neopentane, cyclopentane, or isopentane), hexane, heptane, octane, cyclohexane, methyl cyclohexane, and the like, as well as combinations thereof. Similarly, illustrative examples of aromatic hydrocarbons that can be utilized as the reaction medium, either singly or in combination, include benzene, toluene, xylene, cumene, ethylbenzene, and the like, as well as combinations thereof. Similarly, illustrative examples of ether solvents/diluents that can be utilized as the reaction medium, either singly or in combination, include dimethyl ether, diethyl ether, methyl ethyl ether, furan, dihydrofuran, tetrahydrofuran (THF), and the like, as well as combinations thereof.

The method of making the transition metal compound can be performed at a temperature in a range from −70° C. to 15° C. Thus, the compound having formula (C) can be contacted with the compound having formula (D) at a temperature in a range from −70° C. to 15° C., and/or the transition metal compound having formula (B) can be formed at a temperature in a range from −70° C. to 15° C. Other suitable temperature ranges include from −60 to 10° C., from −50 to 10° C., from −40 to 0° C., from −30 to 15° C., from −20 to 10° C., or from −15 to 10° C., and the like.

While not particularly limited, the molar ratio of the compound having formula (C) to the compound having formula (D) often falls within a range of from 5:1 to 1:5. Other suitable molar ratios include, for instance, from 2:1 to 1:4, from 1:1 to 1:3, or from 1:1.5 to 1:2.5, and the like. In a particular aspect, the molar ratio can be approximately 1:2.

### EXAMPLES

The invention is further illustrated by the following examples, which are not to be construed in any way as imposing limitations to the scope of this invention. Various other aspects, modifications, and equivalents thereof, which after reading the description herein, can suggest themselves to one of ordinary skill in the art without departing from the spirit of the present invention or the scope of the appended claims.

### Example 1

### Preparation of CoCl₂(py)₄

A 20 mL glass vial was charged with anhydrous CoCl₂ (2.34 g) and excess neat anhydrous pyridine (10 mL, py). The mixture was stirred for 18 hr at 25° C., forming a pink solution and solid. The solid was collected by filtration, washed with pentane (20 mL) and dried under vacuum, yielding the desired CoCl₂(py)₄ product (6.32 g, 79 mol % yield).

### Example 2

### Preparation of (py)₂Co(CH₂SiMe₃)₂

A pentane (10 mL) slurry of CoCl₂(py)₄ (0.40 g) was prepared and cooled to −10° C., resulting in a color change in the solid from pink to bright blue. Two equivalents of LiCH₂SiMe₃ (2.5 mL, 0.7 M in hexanes) were added dropwise to the stirred slurry producing a dark mixture over 1 hr. This mixture was then warmed to room temperature and stirred another hour, filtered, and the solvent removed under vacuum, yielding the desired (py)₂Co(CH₂SiMe₃)₂ product as a green tacky solid (0.24 g).

### Example 3

### Preparation of (py)₂(Me₃SiCH₂)Co/SiO₂

The transition metal compound (py)₂Co(CH₂SiMe₃)₂ (0.068 g) was dissolved in 5 mL pentane and added dropwise to a pentane slurry of SiO₂ (0.20 g in 5 mL) at 25° C. The silica was previously calcined at 550° C. Other diluents can be used instead of pentane, such as ethers or aromatic hydrocarbons. The mixture was stirred for 1 hr and then filtered to collect a lavender solid (0.18 g) that was dried under vacuum, yielding the supported transition metal catalyst. EDS analysis confirmed cobalt impregnation (2.1 relative wt. % Co) and some ligand retention (5.7 relative wt. % C). Energy dispersive x-ray spectroscopy (EDS) was acquired using a JEOL model JSM-6610LV scanning electron microscope (SEM) with an Oxford Instruments model INCA Energy 350 EDS system. The system used an Oxford Instruments X-Max 80 mm² silicon drift detector (SDD). The semi-quantitative elemental analysis results were normalized to 100%.

### Example 4

### Preparation of FeCl₂(py)₄

A 20 mL glass vial was charged with anhydrous FeCl₂ (1.10 g) and excess neat anhydrous pyridine (10 mL, py). The mixture was stirred for 4 hr at 25° C., forming a bright yellow solid. The solid was collected by filtration, washed with pentane (10 mL) and dried under vacuum, yielding the desired FeCl₂(py)₄ product (3.10 g, 82 mol % yield).

### Example 5

### Preparation of (py)₂Fe(CH₂SiMe₃)₂

A diethyl ether (10 mL) and pyridine (0.25 mL) slurry of FeCl₂(py)₄ (0.22 g) was prepared and cooled to −10° C. Two equivalents of Me₃SiCH₂MgCl (1.0 mL, 1 M in diethyl ether) were added dropwise to the stirred slurry producing a bright red mixture over 15 min. This mixture was then warmed to room temperature and stirred another hour. The solvent was removed under vacuum, the product extracted with pentane, filtered and then dried, yielding the desired (py)₂Fe(CH₂SiMe₃)₂ product as a red oil (0.1 g).

### Example 6

### Preparation of (py)₂(Me₃SiCH₂)Fe/SiO₂

The transition metal compound (py)₂Fe(CH₂SiMe₃)₂ (0.060 g) was dissolved in 10 mL pentane and added dropwise to a pentane slurry of SiO₂ (0.19 g in 5 mL) at 25° C. The silica was previously calcined at 550° C. Other diluents can be used instead of pentane, such as ethers or aromatic hydrocarbons. The mixture was stirred for 18 hr and then filtered to collect a dark yellow solid (0.20 g) that was dried under vacuum, yielding the supported transition metal catalyst. EDS analysis confirmed iron impregnation (3.2 relative wt. % Fe) and some ligand retention (8.4 relative wt. % C).

### Example 7

### Preparation of (py)₂(Neopentyl)Fe/Sulfated Alumina

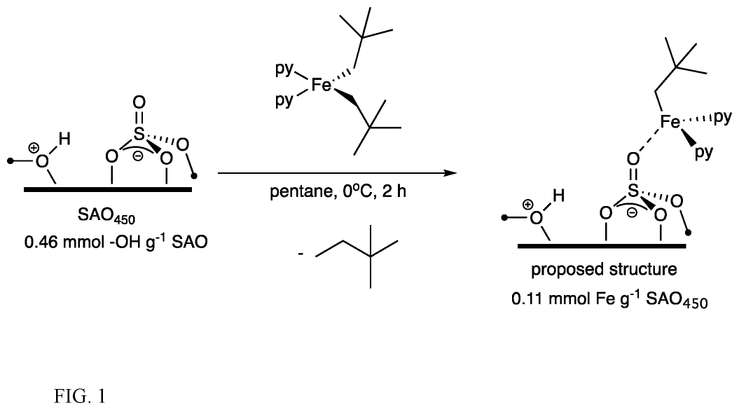

The (py)₂Fe(neopentyl)₂ transition metal compound was prepared in accordance with the procedure described in Fernández et al, Organometallics 2008, 27, 109-118. The transition metal compound (py)₂Fe(neopentyl)₂ (0.11 mmol Fe/g sulfated alumina) was then dissolved in pentane and mixed with 0.25 g of sulfated alumina (0.46 mmol —OH/g, SAO) for 2 hr at 0° C. The sulfated alumina was previously calcined at 450° C. and prepared as described in Nicholas et al, J. Am. Chem. Soc. 2003, 125, 4325-4331. The solid was collected by filtration and dried under vacuum, yielding the supported transition metal catalyst. While not wishing to be bound by the following theory, FIG. 1 illustrates a proposed illustration of the supported iron catalyst structure, in which one neopentyl group is removed from the transition metal compound.

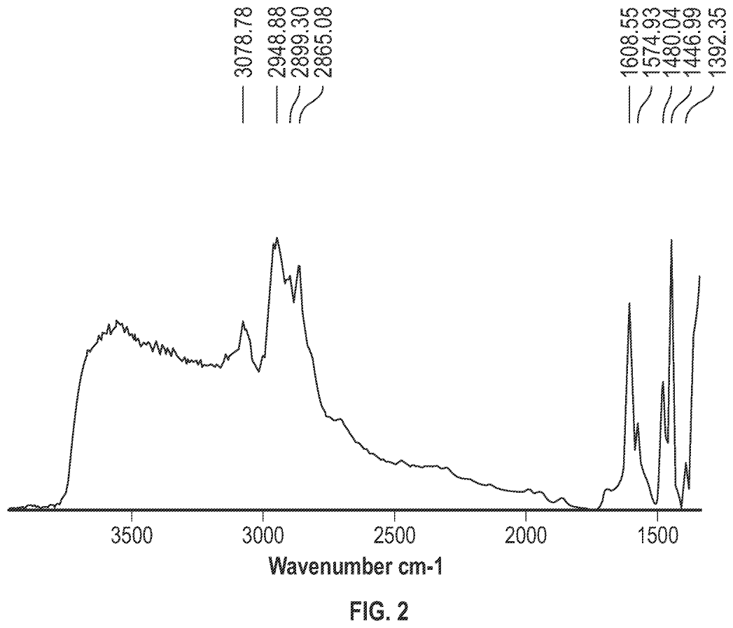

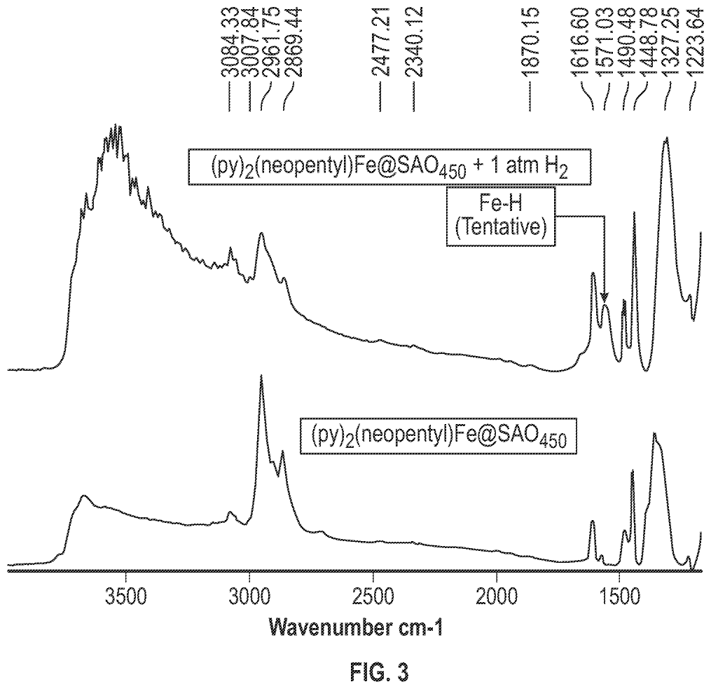

As shown in FIG. 2, FT-IR of the solid supported catalyst confirmed pyridine coordination showing C—N aromatic stretches in the 1600 cm⁻¹ range. A separate experiment measuring neopentane formation by GC-FID confirmed one neopentane was released per available surface hydroxyl group consistent with the catalyst impregnation and formation. FIG. 3 illustrates the result of treating the supported iron catalyst with 1 atm of hydrogen (H₂) for 1 hr at room temperature, forming the related hydride (H) and elimination of the neopentyl group.

FT-IR spectra were collected using a Bruker Alpha IR spectrometer in an argon-filled glovebox. For gas phase GC product quantification, the GC column oven was held at 150° C. for 10 min, then 200 μL of gas sample was injected, and split ratio was 80:1. The temperature of FID was set at 350° C. and N₂ was used as the carrier gas with a flow rate of 23.7 mL/min. The flow rate of air and hydrogen was set at 400 mL/min and 30 mL/min, respectively. Gas quantification was calculated based on the following equation:

$$\frac{( \frac{Area of peak}{Number of carbon atoms} )}{Response Factor} \times V ( L ) = n ( mol ) R T ( K )$$

For liquid phase product identification, the GC column oven was held at 45° C. for 1 min and the temperature was subsequently raised to 275° C. (at 5° C./min) and held at this temperature for 5 min. A 5 μL liquid sample was injected, and the split ratio was 100:1. The temperature of FID was set at 350° C. and N₂ was used as the carrier gas with a flow rate of 25 mL/min. The flow rate of air and hydrogen was set at 400 mL/min and 30 mL/min, respectively.

The invention is described above with reference to numerous aspects and specific examples. Many variations will suggest themselves to those skilled in the art in light of the above detailed description. All such obvious variations are within the full intended scope of the appended claims. Other aspects of the invention can include, but are not limited to, the following (aspects are described as “comprising” but, alternatively, can “consist essentially of”or “consist of”):

Aspect 1. A supported catalyst comprising a transition metal compound having formula (A) or formula (B) impregnated on (or bound to) a solid support, wherein formula (B) is (L)ₓMR₂, and formula (A) is:

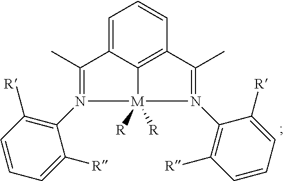

wherein: M is Fe, Co, or Mn; each R independently is a C₁-C₁₈ hydrocarbyl group or a C₁-C₁₈ hydrocarbylsilyl group; each R′ and R″ independently are H or a C₁-C₁₈ hydrocarbyl group; L is a monodentate, bidentate, or tridentate ligand; and x is equal to 1 or 2.

Aspect 2. The supported catalyst defined in aspect 1, wherein M is Fe.

Aspect 3. The supported catalyst defined in aspect 1, wherein M is Co.

Aspect 4. The supported catalyst defined in aspect 1, wherein M is Mn.

Aspect 5. The supported catalyst defined in any one of aspects 1-4, wherein each R independently is a methyl group, an ethyl group, a propyl group (n-propyl group or iso-propyl group), a butyl group (n-butyl group, iso-butyl group, sec-butyl group, or tert-butyl group), a pentyl group (n-pentyl group, iso-pentyl group, sec-pentyl group, or neopentyl group), a hexyl group, a heptyl group, an octyl group, a nonyl group, a decyl group, a cyclobutyl group, a cyclopentyl group, a cyclohexyl group, a cycloheptyl group, an adamantyl group, a phenyl group, a mesityl group, a naphthyl group, or a benzyl group.

Aspect 6. The supported catalyst defined in any one of aspects 1-4, wherein each R independently is a methyl group, a neopentyl group, a phenyl group, a mesityl group, or a benzyl group.

Aspect 7. The supported catalyst defined in any one of aspects 1-6, wherein each R independently is a C₁-C₁₂ hydrocarbylsilyl group, a C₄-C₁₈ hydrocarbylsilyl group, or a C₄-C₁₂ hydrocarbylsilyl group.

Aspect 8. The supported catalyst defined in any one of aspects 1-6, wherein each R independently is CH₂SiMe₃, CH₂CMe₃, CH₂Ph, or CH₂CMe₂Ph.

Aspect 9. The supported catalyst defined in any one of aspects 1-8, wherein each R′ and R″ independently are H, a methyl group, an ethyl group, a propyl group (n-propyl group or iso-propyl group), a butyl group (n-butyl group, iso-butyl group, sec-butyl group, or tert-butyl group), a pentyl group (n-pentyl group, iso-pentyl group, sec-pentyl group, or neopentyl group), a hexyl group, a heptyl group, an octyl group, a nonyl group, a decyl group, a cyclobutyl group, a cyclopentyl group, a cyclohexyl group, a cycloheptyl group, an adamantyl group, a phenyl group, a mesityl group, a naphthyl group, or a benzyl group.

Aspect 10. The supported catalyst defined in any one of aspects 1-8, wherein each R′ and R″ independently are H, a methyl group, an ethyl group, a propyl group (n-propyl group or iso-propyl group), a butyl group (n-butyl group, iso-butyl group, sec-butyl group, or tert-butyl group), or a pentyl group (n-pentyl group, iso-pentyl group, sec-pentyl group, or neopentyl group).

Aspect 11. The supported catalyst defined in any one of aspects 1-10, wherein L is any suitable monodentate ligand, e.g., pyridine or a phosphorus-containing ligand (PMe₃, PEt₃, PEt₂Ph, PBu₃, etc.).

Aspect 12. The supported catalyst defined in any one of aspects 1-11, wherein L is any suitable bidentate ligand, e.g., sparteine, tetramethylethylenediamine (tmeda), or a bisphospine (diphosphine).

Aspect 13. The supported catalyst defined in any one of aspects 1-12, wherein L is any suitable tridentate ligand, e.g., a pyridine dicarbene.

Aspect 14. The supported catalyst defined in any one of aspects 1-13, wherein x is equal to 1.

Aspect 15. The supported catalyst defined in any one of aspects 1-13, wherein x is equal to 2.

Aspect 16. The supported catalyst defined in any one of aspects 1-15, wherein the solid support comprises any suitable solid oxide, e.g., silica, alumina, silica-alumina, silica-coated alumina, aluminum phosphate, aluminophosphate, heteropolytungstate, titania, zirconia, magnesia, boria, zinc oxide, silica-titania, silica-zirconia, alumina-titania, alumina-zirconia, zinc-aluminate, alumina-boria, alumina borate, silica-boria, aluminophosphate-silica, titania-zirconia, or any combination thereof.

Aspect 17. The supported catalyst defined in any one of aspects 1-15, wherein the solid support comprises silica, silica-alumina, silica-coated alumina, silica-titania, silica-titania-magnesia, silica-zirconia, silica-magnesia, silica-boria, aluminophosphate-silica, alumina, alumina borate, or any combination thereof.

Aspect 18. The supported catalyst defined in any one of aspects 1-15, wherein the solid support comprises a chemically-treated solid oxide comprising a solid oxide (e.g., as above, such as silica, alumina, silica-alumina, silica-titania, silica-zirconia, silica-yttria, aluminophosphate, zirconia, titania, thoria, or stania) treated with an electron-withdrawing anion.

Aspect 19. The supported catalyst defined in aspect 18, wherein the electron-withdrawing anion comprises sulfate, bisulfate, fluoride, chloride, bromide, iodide, fluorosulfate, fluoroborate, phosphate, fluorophosphate, trifluoroacetate, triflate, fluorozirconate, fluorotitanate, phospho-tungstate, tungstate, molybdate, or any combination thereof.

Aspect 20. The supported catalyst defined in aspect 18 or 19, wherein the chemically-treated solid oxide contains from 1 to 30 wt. %, from 2 to 20 wt. %, from 2 to 15 wt. %, from 2 to 10 wt. %, or from 3 to 10 wt. %, of the electron-withdrawing anion, based on the total weight of the chemically-treated solid oxide.

Aspect 21. The supported catalyst defined in any one of aspects 1-15, wherein the solid support comprises a chemically-treated solid oxide comprising fluorided alumina, chlorided alumina, bromided alumina, sulfated alumina, fluorided silica-alumina, chlorided silica-alumina, bromided silica-alumina, sulfated silica-alumina, fluorided silica-zirconia, chlorided silica-zirconia, bromided silica-zirconia, sulfated silica-zirconia, fluorided silica-titania, fluorided silica-coated alumina, fluorided-chlorided silica-coated alumina, sulfated silica-coated alumina, phosphated silica-coated alumina, or any combination thereof.

Aspect 22. The supported catalyst defined in any one of aspects 1-21, wherein the supported catalyst contains any suitable amount of transition metal (Fe, Co, or Mn) or an amount in any range disclosed herein, e.g., from 0.01 to 20 wt. %, from 0.01 to 10 wt. %, from 0.05 to 15 wt. %, from 0.1 to 15 wt. %, from 0.2 to 10 wt. %, from 0.1 to 5 wt. %, from 0.5 to 5 wt. %, or from 0.5 to 2.5 wt. % of transition metal (Fe, Co, or Mn), based on the weight of the catalyst.

Aspect 23. The supported catalyst defined in any one of aspects 1-22, wherein the supported catalyst (or the solid support) has any suitable pore volume or a pore volume in any range disclosed herein, e.g., from 0.3 to 5 mL/g, from 0.5 to 5 mL/g, from 0.3 to 3 mL/g, from 0.5 to 2 mL/g, from 0.5 to 1.8 mL/g, or from 0.7 to 1.6 mL/g.

Aspect 24. The supported catalyst defined in any one of aspects 1-23, wherein the supported catalyst (or the solid support) has any suitable BET surface area or a BET surface area in any range disclosed herein, e.g., from 50 to 1000 m²/g, from 100 to 700 m²/g, from 100 to 400 m²/g, from 150 to 500 m²/g, or from 200 to 450 m²/g.

Aspect 25. The supported catalyst defined in any one of aspects 1-24, wherein the supported catalyst (or the solid support) has any suitable d50 average particle size or a d50 average particle size in any range disclosed herein, e.g., from 10 to 500 μm, from 20 to 250 μm, from 20 to 150 μm, from 25 to 500 μm, from 25 to 100 μm, from 50 to 500 μm, or from 50 to 250 μm.

Aspect 26. A method of making a transition metal compound having the following formula: (L)ₓMR₂ (B); the method comprising contacting a compound having formula (C) with a compound having formula (D) in a reaction medium at a temperature in a range from −70° C. to 15° C. to form the compound having formula (B), wherein formula (C) is (L)_{y}MX₂, and formula (D) is LiR, MgRX, MgR₂, or ZnR₂; wherein M is Fe, Co, or Mn; each R independently is a C₁-C₁₈ hydrocarbyl group or a C₁-C₁₈ hydrocarbylsilyl group; L is a monodentate or bidentate ligand; each X independently is a halogen; x is equal to 1 or 2; and y is equal to 2 or 4.

Aspect 27. The method defined in aspect 26, wherein M is Fe.

Aspect 28. The method defined in aspect 26, wherein M is Co.

Aspect 29. The method defined in aspect 26, wherein M is Mn.

Aspect 30. The method defined in any one of aspects 26-29, wherein each R independently is a methyl group, an ethyl group, a propyl group (n-propyl group or iso-propyl group), a butyl group (n-butyl group, iso-butyl group, sec-butyl group, or tert-butyl group), a pentyl group (n-pentyl group, iso-pentyl group, sec-pentyl group, or neopentyl group), a hexyl group, a heptyl group, an octyl group, a nonyl group, a decyl group, a cyclobutyl group, a cyclopentyl group, a cyclohexyl group, a cycloheptyl group, an adamantyl group, a phenyl group, a mesityl group, a naphthyl group, or a benzyl group.

Aspect 31. The method defined in any one of aspects 26-29, wherein each R independently is a methyl group, a neopentyl group, a phenyl group, a mesityl group, or a benzyl group.

Aspect 32. The method defined in any one of aspects 26-31, wherein each R independently is a C₁-C₁₂ hydrocarbylsilyl group, a C₄-C₁₈ hydrocarbylsilyl group, or a C₄-C₁₂ hydrocarbylsilyl group.

Aspect 33. The method defined in any one of aspects 26-31, wherein each R independently is CH₂SiMe₃, CH₂CMe₃, CH₂Ph, or CH₂CMe₂Ph.

Aspect 34. The method defined in any one of aspects 26-33, wherein L is any suitable monodentate ligand, e.g., pyridine or a phosphorus-containing ligand (PMe₃, PEt₃, PEt₂Ph, PBu₃, etc.).

Aspect 35. The method defined in any one of aspects 26-34, wherein L is any suitable bidentate ligand, e.g., sparteine, tetramethylethylenediamine (tmeda), or a bisphospine (diphosphine).

Aspect 36. The method defined in any one of aspects 26-35, wherein xis equal to 1.

Aspect 37. The method defined in any one of aspects 26-35, wherein xis equal to 2.

Aspect 38. The method defined in any one of aspects 26-37, wherein y is equal to 2.

Aspect 39. The method defined in any one of aspects 26-37, wherein y is equal to 4.

Aspect 40. The method defined in any one of aspects 26-39, wherein each X is Cl.

Aspect 41. The method defined in any one of aspects 26-40, wherein the reaction medium comprises a saturated aliphatic hydrocarbon, an aromatic hydrocarbon, an ether, or any combination thereof.

Aspect 42. The method defined in any one of aspects 26-41, wherein the reaction medium comprises any suitable saturated aliphatic hydrocarbon, e.g., butane, pentane, hexane, heptane, octane, cyclohexane, methyl cyclohexane, or combinations thereof.

Aspect 43. The method defined in any one of aspects 26-42, wherein the reaction medium comprises any suitable aromatic hydrocarbon, e.g., benzene, toluene, xylene, cumene, ethylbenzene, or combinations thereof.

Aspect 44. The method defined in any one of aspects 26-43, wherein the reaction medium comprises any suitable ether, e.g., dimethyl ether, diethyl ether, methyl ethyl ether, furan, dihydrofuran, tetrahydrofuran (THF), or combinations thereof.

Aspect 45. The method defined in any one of aspects 26-44, wherein the temperature is in any suitable range, e.g., from −60 to 10° C., from −50 to 10° C., from −40 to 0° C., from −30 to 15° C., from −20 to 10° C., or from −15 to 10° C.

Aspect 46. The method defined in any one of aspects 26-45, wherein a molar ratio of the compound having formula (C) to the compound having formula (D) is in any suitable range, e.g., from 5:1 to 1:5, from 2:1 to 1:4, from 1:1 to 1:3, from 1:1.5 to 1:2.5, or approximately 1:2.

We claim:

1. A supported catalyst comprising:
a transition metal compound having formula (A) or formula (B) impregnated on a solid support, wherein formula (B) is (L)ₓMR₂, and formula (A) is: 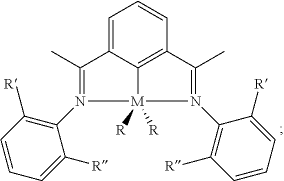
wherein:
M is Fe, Co, or Mn;
each R independently is a C₁-C₁₈ hydrocarbyl group or a C₁-C₁₈ hydrocarbylsilyl group;
each R′ and R″ independently are H or a C₁-C₁₈ hydrocarbyl group;
L is a monodentate, bidentate, or tridentate ligand; and
x is equal to 1 or 2.

2. The supported catalyst of claim 1, wherein the transition metal compound has formula (A).

3. The supported catalyst of claim 1, wherein the transition metal compound has formula (B).

4. The supported catalyst of claim 1, wherein each R independently is a methyl group, an ethyl group, a propyl group, a butyl group, a pentyl group, a hexyl group, a heptyl group, an octyl group, a nonyl group, a decyl group, a cyclobutyl group, a cyclopentyl group, a cyclohexyl group, a cycloheptyl group, an adamantyl group, a phenyl group, a mesityl group, a naphthyl group, or a benzyl group.

5. The supported catalyst of claim 1, wherein each R independently is CH₂SiMe₃, CH₂CMe₃, CH₂Ph, or CH₂CMe₂Ph.

6. The supported catalyst of claim 1, wherein each R′ and R″ independently are H, a methyl group, an ethyl group, a propyl group, a butyl group, a pentyl group, a hexyl group, a heptyl group, an octyl group, a nonyl group, a decyl group, a cyclobutyl group, a cyclopentyl group, a cyclohexyl group, a cycloheptyl group, an adamantyl group, a phenyl group, a mesityl group, a naphthyl group, or a benzyl group.

7. The supported catalyst of claim 1, wherein L is pyridine, a phosphorus-containing ligand, sparteine, tetramethylethylenediamine, a bisphospine, or a pyridine dicarbene.

8. The supported catalyst of claim 1, wherein the solid support comprises a solid oxide comprising silica, alumina, silica-alumina, silica-coated alumina, aluminum phosphate, aluminophosphate, heteropolytungstate, titania, zirconia, magnesia, boria, zinc oxide, silica-titania, silica-zirconia, alumina-titania, alumina-zirconia, zinc-aluminate, alumina-boria, alumina borate, silica-boria, aluminophosphate-silica, titania-zirconia, or any combination thereof.

9. The supported catalyst of claim 1, wherein the solid support comprises a chemically-treated solid oxide comprising fluorided alumina, chlorided alumina, bromided alumina, sulfated alumina, fluorided silica-alumina, chlorided silica-alumina, bromided silica-alumina, sulfated silica-alumina, fluorided silica-zirconia, chlorided silica-zirconia, bromided silica-zirconia, sulfated silica-zirconia, fluorided silica-titania, fluorided silica-coated alumina, fluorided-chlorided silica-coated alumina, sulfated silica-coated alumina, phosphated silica-coated alumina, or any combination thereof.

10. The supported catalyst of claim 1, wherein the supported catalyst contains from 0.01 to 20 wt. % Fe, Co, or Mn, based on the weight of the catalyst.

11. The supported catalyst claim 1, wherein the supported catalyst has:
a pore volume from 0.3 to 5 mL/g;
a BET surface area from 50 to 1000 m²/g; and
a d50 average particle size from 10 to 500 μm.

12. The supported catalyst of claim 1, wherein the solid support has:
a pore volume from 0.3 to 5 mL/g;
a BET surface area from 50 to 1000 m²/g; and
a d50 average particle size from 10 to 500 μm.

13. A method of making a transition metal compound having the following formula: (L)ₓMR₂ (B); the method comprising:
contacting a compound having formula (C) with a compound having formula (D) in a reaction medium at a temperature in a range from −70° C. to 15° C. to form the compound having formula (B), wherein:
formula (C) is (L)_{y}MX₂, and
formula (D) is LiR, MgRX, MgR₂, or ZnR₂; wherein:
M is Fe, Co, or Mn;
each R independently is a C₁-C₁₈ hydrocarbyl group or a C₁-C₁₈ hydrocarbylsilyl group;
L is a monodentate or bidentate ligand;
each X independently is a halogen;
x is equal to 1 or 2; and
y is equal to 2 or 4.

14. The method of claim 13, wherein each R independently is a methyl group, an ethyl group, a propyl group, a butyl group, a pentyl group, a hexyl group, a heptyl group, an octyl group, a nonyl group, a decyl group, a cyclobutyl group, a cyclopentyl group, a cyclohexyl group, a cycloheptyl group, an adamantyl group, a phenyl group, a mesityl group, a naphthyl group, or a benzyl group.

15. The method of claim 13, wherein each R independently is CH₂SiMe₃, CH₂CMe₃, CH₂Ph, or CH₂CMe₂Ph.

16. The method of claim 13, wherein each X is Cl.

17. The method of claim 13, wherein L is pyridine, a phosphorus-containing ligand, sparteine, tetramethylethylenediamine, or a bisphospine.

18. The method of claim 13, wherein the reaction medium comprises a saturated aliphatic hydrocarbon, an aromatic hydrocarbon, an ether, or any combination thereof.

19. The method of claim 13, wherein the temperature is from −30 to 15° C.

20. The method of claim 13, wherein a molar ratio of the compound having formula (C) to the compound having formula (D) is from 1:1 to 1:3.
